(19) United States
(12) Patent Application Publication
(10) Pub. No.: US 2014/0147222 A1
(43) Pub. Date: May 29, 2014

(54) PORTABLE EQUIPMENT FOR MACHINING A LOWER PORTION OF AN AIRCRAFT LANDING GEAR CASING

(71) Applicants: Pessin Jérôme, Velizy-Villacoublay (FR); Labarrere Christian, Velizy-Villacoublay (FR); Soukia Frédéric, Velizy-Villacoublay (FR)

(72) Inventors: Pessin Jérôme, Velizy-Villacoublay (FR); Labarrere Christian, Velizy-Villacoublay (FR); Soukia Frédéric, Velizy-Villacoublay (FR)

(73) Assignee: MESSIER-BUGATTI-DOWTY, Velizy-Villacoublay (FR)

(21) Appl. No.: 14/118,686

(22) PCT Filed: May 22, 2012
(86) PCT No.: PCT/EP2012/059516

§ 371 Date: Jan. 17, 2014

(30) Foreign Application Priority Data
May 23, 2011 (FR) 11 54476

(51) Int. Cl. B23B 41/02; B25H 1/00

(52) U.S. Cl. CPC B23B 41/02; B25H 1/0021
USPC 408/1 R; 408/109

(57) ABSTRACT

Portable tooling for machining a bottom portion of an aircraft landing gear strut having a plurality of orifices. The portable tooling comprising a collar for positioning it on the bottom portion of the strut, at least one indexing member for angularly indexing the collar on the strut and for preventing it from moving, and a support that is removably fitted on the collar and that is fitted with a motor-driven machining spindle that carries a tool mounted to move on the support along a direction converging on the strut in order to machine an orifice extending in register with the tool. The collar is arranged in such a manner as to be capable of receiving the support in a plurality of angular positions, in each of which the tool extends in register with one of the orifices to be machined.

The invention relates to portable tooling for machining the bottom portion of an aircraft landing gear strut.

### TECHNOLOGICAL BACKGROUND OF THE INVENTION

Landing gear generally comprises a leg in the form of a strut having a rod slidably mounted therein. The bottom portion of the rod carries the wheels of the landing gear.

The strut has a bearing in its bottom portion for guiding the sliding of the rod inside the strut. This bearing is engaged in an end bore of the strut and is held by pegs.

It is found that certain portions of the strut, and in particular the orifices extending through the bottom portion of the strut, are liable under certain circumstances to corrode rapidly, thereby requiring corrective action to be taken, generally removal of the strut so that it can be sent to a repair workshop, which constitutes an operation that is rather cumbersome.

### OBJECT OF THE INVENTION

The invention seeks to provide a device enabling action to be taken on the landing gear strut while the strut is still in place on the aircraft.

### BRIEF SUMMARY OF THE INVENTION

In order to achieve this object, the invention provides portable tooling for machining a bottom portion of an aircraft landing gear strut, the tooling comprising a collar for positioning it on the bottom portion of the strut, at least one indexing member for angularly indexing the collar on the strut and for preventing it from moving, a support that is removably fitted on the collar and that is fitted with a motor-driven machining spindle that carries a tool mounted to move on the support along a direction converging on the strut in order to machine an orifice extending in register with the tool, the collar being arranged in such a manner as to be capable of receiving the support in a plurality of angular positions, in each of which the tool extends in register with one of the orifices to be machined.

The tooling thus makes it possible to limit disassembly operations performed on the landing gear and to take action directly under the aircraft. In order to re-bore orifices that have suffered from corrosion, it suffices to depressurize the shock absorber of the landing gear, possibly by emptying out its oil, and then to remove the rod from the strut in order to be able to remove its bottom bearing, together with the rotary sleeve that is mounted around the bottom portion of the strut in order to receive one of the arms of a steering scissors linkage. The orifices that need to be repaired are then visible and accessible, and it suffices to present the collar of the tool in order to put it into place on the bottom portion of the strut. The collar is then indexed and the support is fitted onto the collar so that the reamer tool then extends in register with one of the orifices to be re-bored. It then suffices to activate the machining spindle and proceed with machining the orifice.

Thereafter, the support is moved on the collar to another angular position in order to machine another orifice, and so on.

Once this operation has been finished, the tooling is removed, or where appropriate turned around the strut in order to proceed with re-boring another orifice.

In a particular aspect of the invention, the collar has a series of guides extending in register with each of the orifices for machining and serving either to receive an indexing member for indexing the collar on the strut, or else serving to guide the tool while machining the orifice in register therewith.

### DESCRIPTION OF THE FIGURES

The invention can be better understood in the light of a following particular embodiment of the invention described with reference to the figures of the accompanying drawing, in which:

FIG. 1 is a perspective view of a strut having tooling of the invention fitted thereon;

FIG. 2 is a longitudinal section view of the FIG. 1 strut, provided with tooling of the invention; and

FIG. 3 is a plan view of the tooling of the invention.

### DETAILED DESCRIPTION OF THE FIGURES

The tooling of the invention is used in this example for re-boring orifices in a landing gear strut 1. The strut may still be mounted on the aircraft, with the sliding rod removed. The strut may also be separated from the aircraft in order to be repaired in a hangar in which the aircraft is stored, or in a nearby workshop.

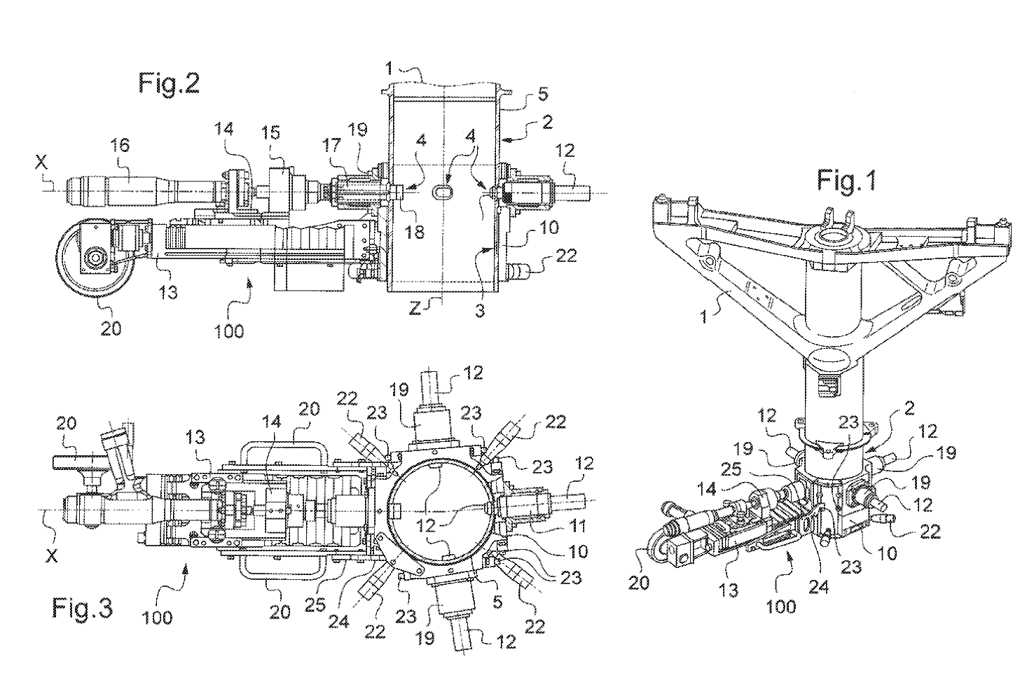

FIG. 1 shows the strut in its position under the aircraft, with the sliding rod removed.

The strut 1 has a generally cylindrical bottom portion of axis Z that presents a cylindrical outside surface 2 that normally receives a rotary sleeve forming a portion of the steering member used for steering the wheels of the landing gear. The sleeve has been removed, as have the plates receiving the steering actuators that act on the sleeve in order to turn it.

Furthermore, the strut 1 has a cylindrical inside surface 3 in its bottom portion that normally receives a sliding bearing for a rod that is mounted to slide telescopically in the strut. In this example the rod has been removed.

Orifices 4 are pierced in the wall 5 of the bottom portion of the strut 1, in radial directions in this example. These orifices 4 are for receiving indexing pegs of the bearing or of members for fastening the bearing. These orifices 4 are in danger of becoming corroded, and it is important to be able to re-bore them in order to eliminate any surface corrosion.

For this purpose, the invention proposes portable machining tooling 100 comprising a collar 10 suitable for fitting around the bottom portion of the strut 1.

The collar 10 has indexing fingers 12 (e.g. expandable pegs) for penetrating in respective ones of the orifices 4 of the strut in order to index the collar 10 angularly around the longitudinal axis of the strut 1 and hold the tooling thereon. There are three indexing fingers 12 in this example, and they are inserted into guides 19 in the collar 10 that extend facing orifices to be made in the strut. One of the guides 19 is left free.

A support 13 is releasably fitted on the collar 10. The support 13 has a carriage 14 that is movable along a direction X that converges towards the strut and that coincides with the axis of the guides 19 that have been left free. The carriage 14 carries a reaming spindle 15 having a motor 16 for driving a reamer 17 in rotation that is terminated by a guide endpiece 18. The reaming spindle 15 is mounted to move on the support 13 along the direction X. The reamer 17 extends facing one of the orifices in the strut. It suffices to switch on the motor of the reaming spindle 15 and to move the carriage 14 using the handle 20 in order to re-bore the orifice 4 in register therewith, the reaming spindle 15 moving together with the carriage 14, the reamer being guided by the guide 19.

In order to re-bore another orifice 4, the support 13 is separated from the collar 10. An indexing finger 12 is placed in the guide 19 and in the re-bored orifice, and an indexing finger 12 is extracted from one of the other guides 19. The support 13 is replaced on the collar 10 so that the reamer 17 extends facing the guide 19 that has been freed in this way. The facing orifice is then re-bored. This is repeated so as to re-bore all of the orifices, with the support 13 being moved each time relative to the collar 10.

In order to make the portable tooling of the invention easier to handle, it is provided with loops 21 extending on either side of the support 13, and with handles 22 fastened to the bottom of the collar 10.

The fastening of the support 13 on the collar 10 is described in detail below with reference to FIGS. 1 and 3. Each guide 19 present on the collar 10 has two cylindrical positioning studs 23 situated on either side of the guide 19 and extending in a plane perpendicular to the axis of the indexing finger 12 and to the axis Z of the strut 1. Each stud 23 co-operates with the curved portion of a hook 24 secured to the support 13 so that the support is held in position relative to the collar by these two hooks 24. In this example, each hook 24 is incorporated in a rectangular plate 25 bolted onto the side faces of the support 13. The support 13 is removed by moving it in translation in a direction parallel to the axis Z of the strut 1 until the hooks 24 have been disengaged from the studs 23. The support can then be brought into register with a new orifice for machining. This produces a collar having means for fastening the machining support 13 in a plurality of distinct locations, each location in register with one of the orifices that is to be machined.

Naturally, the invention is not limited to re-boring operations. For example, a drill bit could be fitted to the spindle for the purpose of enlarging the orifices.

1. A portable tooling for machining a bottom portion of an aircraft landing gear strut having a plurality of orifices, the portable tooling being characterized in that said portable tooling comprises a collar for positioning said portable tooling on the bottom portion of the strut, at least one indexing member for angularly indexing the collar on the strut and for preventing said collar from moving, a support that is removably fitted on the collar and that is fitted with a motor-driven machining spindle that carries a tool mounted to move on the support along a direction converging on the strut in order to machine an orifice extending in register with the tool, the collar being arranged in such a manner as to be capable of receiving the support in a plurality of angular positions, in each of which the tool extends in register with one of the orifices to be machined.

2. The portable tooling according to claim 1, wherein the support includes a carriage movably mounted on the support, the carriage receiving the reaming spindle that moves together with the carriage.

3. The portable tooling according to claim 1, wherein the collar has a plurality of guides, each extending in register with one of the orifices in the strut, and serving either to receive an indexing member or else to guide the tool during machining of the orifice.

4. A method of using portable tooling for machining a bottom portion of an aircraft landing gear strut having a plurality of orifices, the portable tooling comprising a collar for positioning said portable tooling on the bottom portion of the strut, at least one indexing member for angularly indexing the collar on the strut and for preventing said collar from moving, a support that is removably fitted on the collar and that is fitted with a motor-driven machining spindle that carries a tool mounted to move on the support along a direction converging on the strut in order to machine an orifice extending in register with the tool, the collar being arranged in such a manner as to be capable of receiving the support in a plurality of angular positions, in each of which the tool extends in register with one of the orifices to be machined, the method comprising the steps of:
a) fitting the collar on the bottom portion of the strut, and preventing said collar from moving thereon by indexing said collar;
b) fitting the support on the collar in such a manner that the tool extends in register with an orifice for machining;
c) machining the orifice;
d) removing the support and reinstalling the support on the collar in such a manner that the tool extends in register with one of the other orifices to be machined;
e) machining the one of the other orifices; and
f) repeating steps d) and e).
